(19) United States
(12) Patent Application Publication
(10) Pub. No.: US 2007/0281632 A1
(43) Pub. Date: Dec. 6, 2007

(54) Angular domain signal processing techniques

(76) Inventor: Ada Shuk Yan Poon, Champaign, IL (US)

Correspondence Address: KRIEG DEVAULT LLP, ONE INDIANA SQUARE, SUITE 2800, INDIANAPOLIS, IN, 46204-2079, US

(21) Appl. No.: 11/447,227

(22) Filed: Jun. 5, 2006

(51) Int. Cl. H04B 1/02; H04B 1/06; H04M 1/00

(52) U.S. Cl. 455/101; 455/562.1; 455/272

(57) ABSTRACT

A system of the present application includes a first wireless communication device including a number of first device antenna elements, first device processing circuitry, and a first device transmitter to provide a wireless transmission of transmitter vectors corresponding to spatial filters. Also included is a second communication device with a number of second device antenna elements, a second device receiver to receive one or more signals corresponding to the wireless transmission of the transmitter vectors, and second device processing circuitry to generate receiver vectors corresponding to those signals. One or more of the first device and the second device is structured to determine angular spectrum as a function of the transmitter vectors, the receiver vectors, a transmit array manifold, and a receive array manifold.

### BACKGROUND

The present invention relates to wireless communication, and more particularly, but not exclusively relates to methods, systems, devices, and apparatus involving angular domain communication signal processing.

There has been a growing demand for wireless communication devices that have a faster data transfer rate, less power use, and/or better Signal-to-Noise Ratio (SNR)—particularly for battery-powered portable wireless devices. One approach has been the utilization of Multiple-Input Multiple-Output (MIMO) antenna arrangements. Unfortunately, current schemes often result in significant processing overhead. Accordingly, there continues to be a demand for further contributions in this technological area.

### SUMMARY

One embodiment of the present invention is a unique technique involving communication signal processing. Other embodiments include unique methods, systems, devices, and apparatus to process communication signals. Further embodiments, forms, features, aspects, benefits, and advantages of the present application shall become apparent from the description and figures provided herewith.

### BRIEF DESCRIPTION OF THE DRAWING

FIG. 1 is a diagrammatic view of a wireless communication system.

FIG. 2 is a further diagrammatic view of the system of FIG. 1 that illustrates cluster scattering.

FIG. 3 is a flowchart depicting an operating procedure for the system of FIGS. 1 and 2.

FIG. 4 is a flowchart depicting a routine to determine angular spectrum in the procedure of FIG. 3.

FIG. 5 is a flowchart depicting a routine to select an antenna subset based on the angular spectrum determined with the routine of FIG. 4.

FIG. 6 is a flowchart depicting a routine to perform transmit beamforming based on the angular spectrum determined with the routine of FIG. 4.

FIG. 7 is a flowchart depicting a routine to provide a transmit signal space estimation based on the angular spectrum determined with the routine of FIG. 4.

FIG. 8 graphically illustrates the partition of a propagation space into N nonoverlapping cells for N=4, 6, 9, 12, and 16.

FIG. 9 is a graph illustrating the number of spatial filters versus the number of antennas in correspondence to the resolving cells of FIG. 8.

FIG. 10 is a graph illustrating capacity versus the number of antennas for transmit beamforming according to the routine of FIG. 6.

FIG. 11 is a graph illustrating capacity versus the number of antennas for transmit signal space estimation according to the routine of FIG. 7.

FIG. 12 is a graph illustrating the number of spatial channels versus number of antennas for transmit signal space estimation according to the routine of FIG. 7.

FIG. 13 is a graph illustrating the complement cumulative capacity distribution for antenna selection according to the routine of FIG. 5 with N=12.

### DETAILED DESCRIPTION OF REPRESENTATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

As used herein, “antenna element” broadly refers to any type of antenna that transmits and/or receives electromagnetic radiation communication signals, whether or not such antenna is included in an antenna array. One embodiment of the present application includes a unique form of angular domain processing. This processing may include determining angular spectrum for a wireless communication system and applying it to perform antenna selection, signal space estimation, and/or transmit beamforming, to name just a few possibilities. A further embodiment includes a wireless communication device comprising several antennas and processing circuitry to select a subset of the antennas as a function of angle spread associated with the device. In one form, the device includes several Radio Frequency (RF) front end circuits that number fewer than the quantity of antennas and a switching circuit connected between the antennas and the RF front end circuits that is controlled by the processing circuitry.

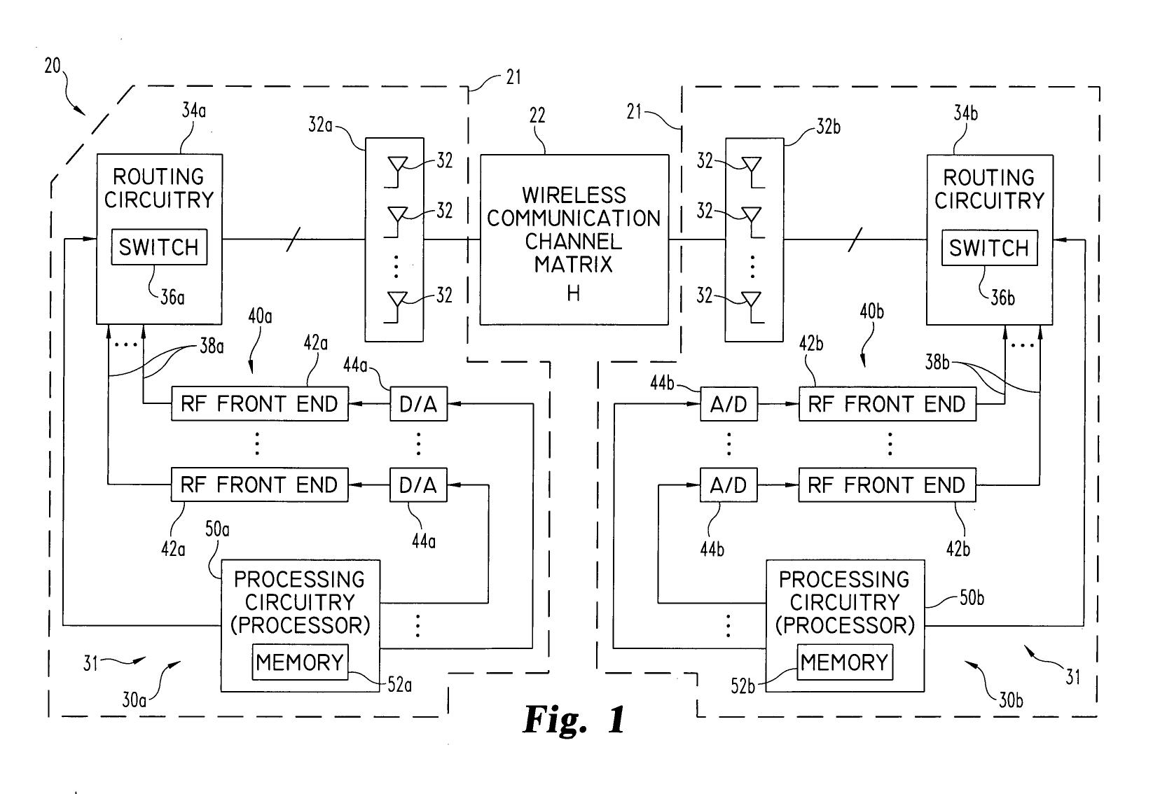

FIG. 1 illustrates wireless communication device system 20 of another embodiment of the present invention. System 20 includes wireless communication device 21a and wireless communication device 21b with multiple wireless communication paths 22 therebetween. Devices 21a and 21b (collectively designated devices 21) can be of any type, including but not limited to a computer with wireless networking, a mobile telephone, a wireless Personal Digital Assistant (PDA), a video display device, and/or an audio device, just to name a few examples. Devices 21 each include components, programming, and circuitry suitable to its particular application. Devices 21 each include a transceiver 31. For device 21a transmitter (TXR) 30a of transceiver 31 is shown in greater detail, and for device 21b receiver (RXR) 30b of transceiver 31 is shown in grater detail. Transceiver 31 of device 21a also includes a receiver that may be the same as receiver 30b, and transceiver 31 of device 21b also includes a transmitter that may be the same as transmitter 30a of device 21a. The receiver and transmitter of devices 21a and 21b, respectively, are not shown to preserve clarity. The TXR and RXR included in each transceiver 31 may be independent devices, or at least partially combined in an integral unit. Typically, but not exclusively, antenna arrays 32a and 32b each are used for both transmitting and receiving.

Devices 21a and 21b include antenna arrays 32a and 32b for wireless transmission and reception of electromagnetic radiation communication signals, respectively. Arrays 32a and 32b each include a number of antenna elements 32. While three elements 32 are shown in each array 32a and 32b, more or fewer may be present. For devices 21 with both transmitter 30a and receiver 30b, the same antenna elements 32 (and corresponding array) can be used for both transmission and reception. For mathematical modeling purposes hereinafter, the number of antenna elements 32 for array 32a is represented by the variable Nₜ and the number of antenna elements 32 for array 32b is represented by the variable Nᵣ; where Nₜ may or may not be equal to Nᵣ. Communications between devices 21a and 21b via respective arrays 32a and 32b can be modeled with channel matrix H.

Devices 21a and 21b each include routing circuitry 34a and 34b, respectively. Routing circuitry 34a includes a corresponding matrix switch 36a and routing circuitry 34b includes a corresponding matrix switch 36b. The Nₜ antenna elements 32 of array 32a are outputs of switch. 36a and the inputs to switch 36a are provided by communication signal pathways 38a. Pathways 38a number less than Nₜ. Switch 36a is structured to selectively route each of signal pathways 38a to a different member of a selected subset of the antenna elements 32 of array 32a in response to control signal input to be more fully described hereinafter. The Nᵣ antenna elements 32 of array 32b are inputs of switch 36b and the outputs to switch 36b are provided by communication signal pathways 38b. Pathways 38b number less than Nᵣ. Switch 36b is structured to connect each of signal pathways 38b to a different member of a selected subset of the antenna elements 32 of array 32b. Switch 36b is structured to route different antenna element subsets of array 32b to pathways 38b in response to control signal input to be more fully described hereinafter.

RF transmission circuitry 40a provides signal pathways 38a. Signal pathways 38a each correspond to a different RF transmission path of device 30a as provided by a different RF front end circuit 42a. Signal pathways 38a and corresponding RF front end circuits 42a can each concurrently transmit a communication signal for transmission with the selected antenna subset via routing circuitry 34a in an independent fashion. Each RF front end circuit 42a is of a standard configuration and has an analog input from a corresponding digital-to-analog (D/A) converter 44a. An analog input is provided to each D/A converter 44a by processing circuitry 50a. Processing circuitry 50a includes memory 52a.

RF receiver circuitry 40b receives input signals from pathways 38b. Signal pathways 38b each correspond to a different RF receiver path of device 30b as provided by a different RF front end circuit 42b. Signal pathways 38b and corresponding RF front end circuits 42b can operate concurrently, each receiving a communication signal from the selected antenna element subset via routing circuitry 34b in an independent fashion. Each RF front end circuit 42b is of a standard configuration and has an analog output to a corresponding analog-to-digital (A/D) converter 44b. An analog output from each A/D converter 44b is provided to digital circuitry 50b. Processing circuitry 50b includes memory 52b. Processing circuitry 50a and 50b is further designated as a form of processor in FIG. 1.

Circuitry 50a, 50b may be provided as a single component, or a collection of operatively coupled components. When of a multi-component form, circuitry 50a, 50b may have one or more components remotely located relative to the others. Circuitry 50a, 50b may include digital circuitry, analog circuitry, a combination of these types, or such different arrangement as would occur to those skilled in the art. Also, circuitry 50a, 50b may be software and/or firmware programmable; a hardwired, dedicated state machine; or a combination of these. In one embodiment, circuitry 50a, 50b is a programmable Digital Signal Processor (DSP) of a solid-state, integrated circuit type that includes one or more processing units and memory. Circuitry 50a, 50b can include signal conditioners, modulators, demodulators, CODECs, one or more Arithmetic Logic Units (ALUs), Central Processing Units (CPUs), limiters, oscillators, control clocks, amplifiers, signal conditioners, filters, format converters, communication ports, clamps, delay devices, and/or different circuitry or functional components as would occur to those skilled in the art to perform desired operations. In one form, circuitry 50a, 50b is of a programmable variety that executes algorithms and processes data in accordance with operating logic that is at least partially defined by programming instructions (such as software or firmware). As an addition or alternative to programming, operating logic for circuitry 50a, 50b can be at least partially defined by hardwired logic or other hardware. When desired, programming instructions (if any) for circuitry 50a, 50b can be stored in memory 52a, 52b. Alternatively or additionally, circuitry 50a, 50b may store data in memory 52a, 52b that is in turn manipulated by the operating logic.

Memory 52a, 52b is included in circuitry 50a, 50b, and can be comprised of one or more components. Memory 52a, 52b can be of a solid-state variety, electromagnetic variety, optical variety, a combination of these forms, and/or such different form as would occur to those skilled in the art. Furthermore, memory 52a, 52b can be volatile, nonvolatile, or a mixture of these types. In one embodiment, memory 52a and 52b are each at least partially integrated with a DSP form of circuitry 50a and 50b.

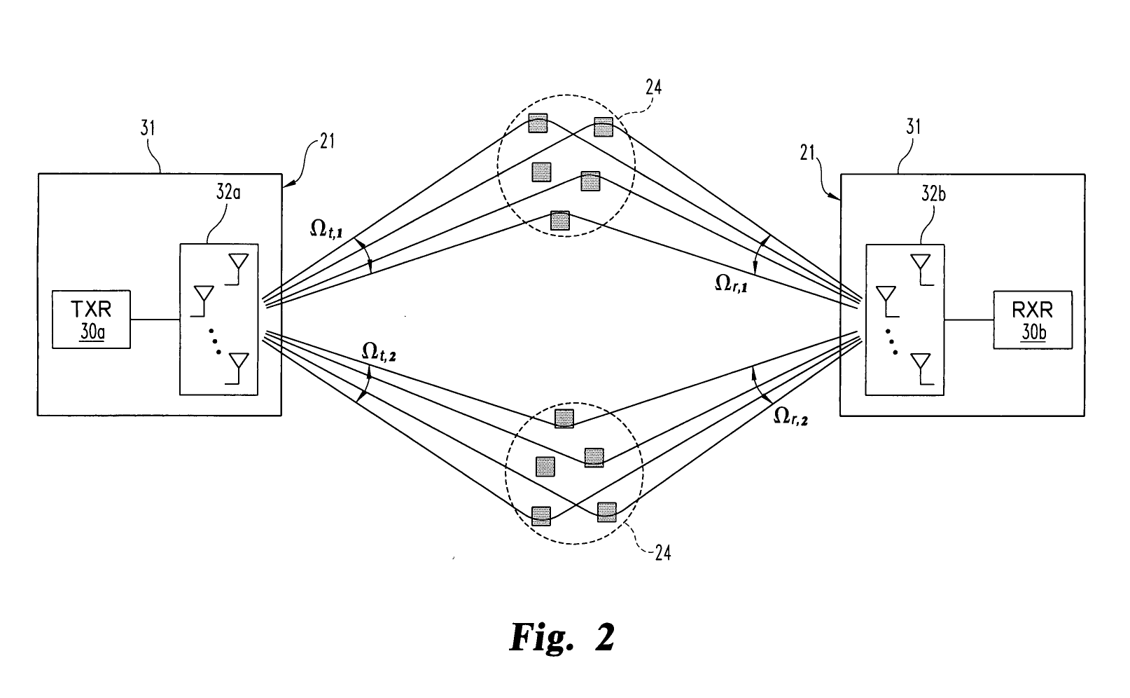

Referring additionally to FIG. 2, transmitter 30a and receiver 30b are shown with multiple scatterers 24 in two representative clusters 24a and 24b; where like reference numerals refer to like features previously described. For indoor and urban environments, it has been discovered that scattering of wireless electromagnetic communication signals can be appropriately modeled as clusters because the distance separating the transmitters and receivers are comparable in size to the scattering clusters. In FIG. 2, the lines extending between the transmission antenna array 32a and the receiver antenna array 32b represent the angular spread of the electromagnetic radiation communication signals resulting from scattering. Clusters 24a and 24b, each subtend respective angular intervals Ω_{t,1} and Ω_{t,2} as illuminated by the transmitter 30a, and respective angular intervals Ω_{r,1} and Ω_{r,2} as observed at the receiver 30b. For the more general case of “z” number of clusters, transmitter angle spread Ωₜ=Ω_{t,1}∩Ω_{t,2}∩ . . . , Ω_{t,z} and receiver angle spread Ωᵣ=Ω_{r,1}∩Ω_{r,2}∩ . . . , Ω_{r,z}.

Angular domain processing applicable to antenna arrays is further developed through the following mathematical modeling, with specific reference to system 20; however, it should be appreciated that such modeling and applications thereof can be applied to many different system types. For mathematical expressions used in this modeling, boldface capital letters designate matrices and boldface small letters designate vectors. Cⁿ and C^{n×m} denote the set of n-dimensional complex vectors and n×m complex matricies, respectively. I_{N} is the N×N identity matrix. CN (0, K) denotes a circularly symmetric complex Gaussian random vector with mean zero and covariance matrix K. Furthermore, the operators ()*, ()^{†}, and E [] denote a complex conjugate, conjugate-transpose, and expectation operation, respectively.

For system 20 with Nₜ transmit antenna elements 32 in antenna array 32a and Nᵣ receive antenna elements 32 in antenna array 32b, the sampled baseband model at the lth subcarrier is represented by expression (1) as follows:

yₗ=Hₗxₗ+zₗ, l=1, . . . , Nₗ (1)

where yₗ ε _{C}Nᵣ, xₗ ε _{C}Nₜ, and zₗ˜CN (0, I_{Nr}) denote the receive signal, the transmit signal, and the additive noise respectively at subcarrier l, and Nₗ is the number of subcarriers. The (i,j)th element of the channel matrix Hₗ ε _{C}Nᵣ×Nₜ gives the complex gain from transmit antenna j to the receive antenna i. The channel matrix Hₗ can be written as the result of the transformation represented by the following mathematical expression (2):

$${H}_{l} = \int \int \int h ( t , \hat{κ} , \hat{k} ) {e}^{- j2π tl Δ f} {a}_{r} ( \hat{κ} ) {a}_{t}^{†} ( \hat{k} ) d t d \hat{κ} d \hat{k} \qquad ( 2 )$$

where Δf denotes the subcarrier spacing. The transmit array manifold aₜ(\hat{k}) ε _{C}Nₜ and the receive array manifold aᵣ(\hat{κ}) ε _{C}Nᵣ capture the characteristics of the transmit and the receive arrays, respectively. In this context, an array manifold corresponds to the set of all source position vectors over a region of interest. The channel impulse response h (t, \hat{κ}, \hat{k}) gives the complex gain between the transmit direction \hat{k} and the receive direction \hat{κ} at time t due to an impulse applied at time zero, and is sometimes referred to as the double-directional channel response. This response characterizes scattering of the physical channel.

If this channel is composed of a finite number of discrete scatters or can be acceptably approximated by the same, the channel impulse response can be modeled by mathematical expression (3) as follows:

$$h ( t , \hat{κ} , \hat{k} ) = \sum {ρ}_{i} δ ( t - {τ}_{i} ) δ ( \hat{κ} - {\hat{κ}}_{i} ) δ ( \hat{k} - {\hat{k}}_{i} ) \qquad ( 3 )$$

where ρᵢ, τᵢ, \hat{κ}ᵢ, and \hat{k}ᵢ are the complex gain, delay, direction of arrival, and direction of departure of the ith physical path. For the union of angular intervals subtended by clusters of scatters being Ωᵣ as observed by the receiver and Ωₜ as irradiated by the transmitter with the scattering being uncorrelated, then the channel impulse model can be further represented by expression (4) as follows:

Eₕ[h(t, \hat{κ}, \hat{k})h*(t′, \hat{κ}′, \hat{k}′)]=P(t, \hat{κ}, \hat{k})δ(t−t′)δ(\hat{κ}−\hat{κ}′)δ(\hat{k}−\hat{k}′) (4)

for which the channel power profile P (t, \hat{κ}, \hat{k}) satisfies expression (5) as follows:

P(t, \hat{κ}, \hat{k})≠only if (t, \hat{κ}, \hat{k}) ε [0, T_{d})×Ωᵣ×Ωₜ (5)

where T_{d} denotes the maximum delay spread. The transmit signal is normalized such that the following equation (5a) holds:

$$E [ {‖ {x}_{l} ‖}^{2} ] = \frac{SNR}{\int \int \int P ( t , \hat{κ} , \hat{k} ) d t d \hat{κ} d \hat{k}} . \qquad ( 5 a )$$

where SNR is the signal-to-noise ratio on each receive antenna.

Common MIMO processing techniques operate with the set of channel matrices {Hₗ}. In contrast, angular domain processing focuses on the direction channel response h (t, \hat{κ}, \hat{k}). The angular spectra, the transmit array, and the receive array are defined by expressions (6), as follows:

$${G}_{h} ( \hat{κ} , \hat{k} ) \text{:} = \int P ( t , \hat{κ} , \hat{k} ) d t \\ {G}_{t} ( \hat{k} ) \text{:} = {‖ {a}_{t} ( \hat{k} ) ‖}^{2} \\ {G}_{r} ( \hat{κ} ) \text{:} = {‖ {a}_{r} ( \hat{κ} ) ‖}^{2} \qquad ( 6 )$$

In correspondence, the short-term transmit and receive correlation matrices can be modeled by expressions (7), as follows:

$${R}_{t} \text{:} = {E}_{h} [ {H}_{l}^{†} {H}_{l} ] = \int \int {G}_{h} ( \hat{κ} , \hat{k} ) {G}_{r} ( \hat{κ} ) {a}_{t} ( \hat{k} ) {a}_{t}^{†} ( \hat{k} ) d \hat{κ} d \hat{k} \\ {R}_{r} \text{:} = {E}_{h} [ {H}_{l} {H}_{l}^{†} ] = \int \int {G}_{h} ( \hat{κ} , \hat{k} ) {G}_{t} ( \hat{k} ) {a}_{r} ( \hat{κ} ) {a}_{r}^{†} ( \hat{κ} ) d \hat{κ} d \hat{k} \qquad ( 7 )$$

These short-term correlations vary as a function of a given physical channel and the array manifolds. Between physical channels, the channel angular spectrum Gₕ (\hat{κ}, \hat{k}) can change and so can the correlation matrices of expressions (7). The long-term transmit and receive correlation matrices are modeled by expressions (8a) and (8b) as follows:

$$\begin{matrix}{E}_{{G}_{h} , h} [ {H}_{l}^{†} {H}_{l} ] = {\overline{G}}_{h} \int {G}_{r} ( \hat{κ} ) d \hat{κ} \int {a}_{t} ( \hat{k} ) {a}_{t}^{†} ( \hat{k} ) d \hat{k} & ( 8 a ) \\ {E}_{{G}_{h} , h} [ {H}_{l} {H}_{l}^{†} ] = {\overline{G}}_{h} \int {G}_{t} ( \hat{k} ) d \hat{k} \int {a}_{r} ( \hat{κ} ) {a}_{r}^{†} ( \hat{κ} ) d \hat{κ} & ( 8 b )\end{matrix}$$

where G̅ₕ=E[Gₕ (\hat{κ}, \hat{k})], which vary as a function of the array manifolds only. It has been surprisingly discovered that the array manifolds can be estimated from the long-term correlation matrices of expressions (8a) and (8b) without prior information regarding the array configuration during manufacture or array calibration at start-up. Accordingly, the transmit array manifold can be estimated a priori at the transmitter and the receive array manifold can be estimated a priori at the receiver.

With the array manifolds known, the short-term transmit correlation matrix Rₜ can be determined from expression (8c) as follows:

$${G}_{h}^{t} ( \hat{k} ) \text{:} = \int {G}_{h} ( \hat{κ} , \hat{k} ) {G}_{r} ( \hat{κ} ) d \hat{κ} \qquad ( 8 c )$$

Likewise, the transmission beamforming vectors can be determined—being the eigenvectors of short-term transmit correlation matrix Rₜ. If the resolution on \hat{k} equals the number of transmit antennas Nₜ for this beamforming application, the feedback rate is Nₜ parameters per physical channel, which is independent of the number of beamforming vectors M. For the standard feedback approach for the first M eigenvectors, a feedback rate of about 2NₜM-M²ᵣₑₛᵤₗₜₛ. Compared to this standard approach, a feedback rate of Nₜ parameters represents an Nₜ-fold savings for M=Nₜ and approximately a 2-fold advantage for M=1.

On a per channel basis, the transmit signal space corresponds to the signal space of Rₜ. Given that Gₕ^{t}(\hat{k}) is nonzero only over Ωₜ, the column space of the matrix Rₜ is a subspace of Aₜ(Ωₜ) as defined in the following expression (9):

$${A}_{t} ( {Ω}_{t} ) \text{:} = {\int }_{{Ω}_{t}} {a}_{t} ( \hat{k} ) {a}_{t}^{†} ( \hat{k} ) d \hat{k} \qquad ( 9 )$$

With the application of a suitable threshold in defining the scattering angular intervals for Ωₜ, the column space of Aₜ(Ωₜ) spans the transmit signal space. Accordingly, the transmit signal space can be determined as a function of Ωₜ. Likewise, with appropriate parameters, the receive signal space can be determined as a function of Ωᵣ. Typically, these scattering intervals do not vary with frequency, and vary with time slower than most fading of signals. By estimating Ωₜ and Ωᵣ at the receiver and sending the estimated Ωₜ back to the transmitter, a more optimal performance can be realized compared to existing schemes.

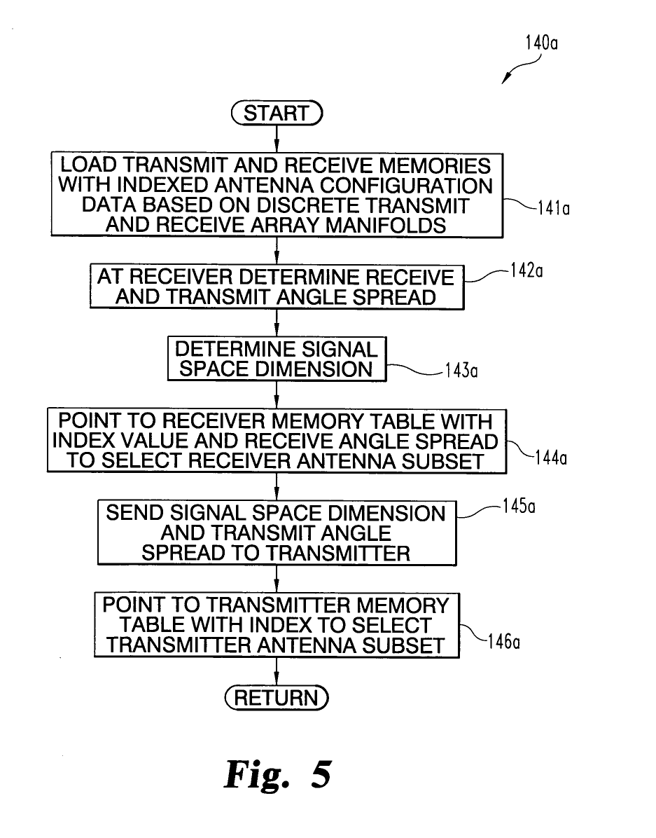

For low-rank channels, the dimension of the transmit signal space Dₜ and that of the receive signal space Dᵣ are less than the minimum of Nₜ and Nᵣ. This inequality can make it attractive to use fewer antennas. With fewer antennas, selection of the appropriate subset arises. Typically, D out of Nₜ transmit antennas and D out of Nᵣ receive antennas are selected for a given subset with D being the minimum of the set {Dₜ, Dᵣ}. Antenna subset selection can also be desired in arrangements that have more antennas than RF front end circuits. Surprisingly, it has been found that a desirable antenna selection pattern, corresponding to a subset of available antennas, can be obtained as a function of total angle spread |Ωₜ| and |Ωᵣ| by minimizing a selected worse-case performance metric. With a resolution on \hat{k} that is equal to the number of transmit antennas Nₜ, |Ωₜ| has only Nₜ possible values. Each of these values corresponds to a different selection pattern that can be pre-computed a priori and corresponding information stored in memory 52a and/or 52b. For each physical channel, the estimated |Ωₜ| can operate as a pointer to a uniquely corresponding antenna subset described the stored information in memory 52a and/or 52b without significant real-time calculations and without the complexity associated with existing antenna selection schemes. Antenna selection as a function of angle spread, which in turn is determined as a function of angular spectrum, is further described hereinafter in connection with FIG. 5; however, a discrete form of angular domain modeling is first described.

A discrete representation can be utilized to estimate angular spectrum by partitioning the angular region reachable by the transmit antenna array into Nₜ non-overlapping cells, as represented in expression (10) as follows:

Ωₜ^{full}=C_{t,1}∪C_{t,2}∪ . . . ∪C_{t,N}_{ₜ} (10)

where each cell is not required to have the same size and can contain multiple disjoint intervals. Accordingly, the angular region visible to the receive array is partitioned into Nᵣ non-overlapping cells as represented by expression (11) as follows:

Ωᵣ^{full}=C_{r,1}∪C_{r,2}∪ . . . ∪C_{r,N}_{ᵣ} (11)

Discrete forms of the transmit and receive array manifolds result as represented by expressions (12), as follows:

A_{t,j}:=Aₜ(C_{t,j}) A_{r,i}:=Aᵣ(C_{r,i}) (12)

Correspondingly, the angular spectra of the transmit array and the receive array are represented by expressions (13), as follows:

$${G}_{t , j} \text{:} = {\int }_{{C}_{t , j}} {G}_{t} ( \hat{k} ) d \hat{k} \\ {G}_{r , i} \text{:} = {\int }_{{C}_{r , i}} {G}_{r} ( \hat{κ} ) d \hat{κ} \qquad ( 13 )$$

for all i=1, . . . , Nᵣ and j=1, . . . , Nₜ. These parameters can be estimated a priori form the long-term correlation (see expressions (8a) and (8b)). A discrete form of the channel angular spectrum is provided by expression (14) as follows:

$${G}_{h , ij} \text{:} = \frac{1}{\vert {C}_{t , j} \vert \vert {C}_{r , i} \vert} {\int }_{{C}_{t , j}} {\int }_{{C}_{r , i}} {G}_{h} ( \hat{κ} , \hat{k} ) d \hat{κ} d \hat{k} \qquad ( 14 )$$

### Expression (14) is the average of Gₕ (\hat{κ}, \hat{k}) over the cells C_{r,i}×C_{t,j}. The short-term transmit correlation matrix correspondingly can be approximated in accordance with expression (15):

$$R \approx {\sum }_{ij} {G}_{h , ij} {G}_{r , i} {A}_{t , j} \qquad ( 15 )$$

The transmit beamforming matrix is estimated from the sequence {ΣᵢG_{h,ij}G_{r,i}}, which has Nₜ parameters. A corresponding feedback rate for transmission beamforming is Nₜ symbols per physical channel. Letting θₜₕ be the threshold for which ΣᵢG_{h,ij}G_{r,i}>θₜₕ is true, then there are physical paths connecting the transmit directions in C_{t,j} to the receiver. Denoting the discrete form of the scattering angular intervals Ωₜ by ℑₜ ε {0,1}N^{N}^{ₜ} where its jth element is given by expression (16) as follows:

$${𝒥}_{t , j} = \{ \begin{matrix}1 , & when {\sum }_{i} {G}_{h , ij} {G}_{r , i} > {θ}_{th} \\ 0 , & otherwise .\end{matrix} \qquad ( 16 )$$

Then, the Aₜ (Ωₜ) of expression (9) can be approximated per expression (17) as follows:

$${A}_{t} ( {Ω}_{t} ) \approx {\sum }_{i} {𝒥}_{t , j} {A}_{t , j} \qquad ( 17 )$$

The transmit signal space can them be estimated from ℑₜ and the corresponding feedback rate is Nₜ bits per physical channel. Accordingly, the discrete form of the scattering angular intervals Ωᵣ can be denoted by ℑᵣ ε {0,1}^{N}^{ᵣ}. It should be appreciated that for beamforming, a subspace of the entire transmit signal space is estimated, which follows from the estimation of {ΣᵢG_{h,ij}G_{r,i}}; however, estimation of the entire signal space follows from the estimation of whether ΣᵢG_{h,ij}G_{r,i} exceeds a certain threshold.

The rank of the correlation matrices Rₜ and Rₜ can be approximated as represented by expressions (18) as follows:

rank(Rₜ)≈|Jₜ| rank(Rᵣ)≈|Jᵣ| (18)

where |ℑ|:=Σᵢℑᵢ. Letting D=minimum of {|ℑₜ|,|ℑᵣ|}, a subset of D number of transmit antennas and receive antennas can be selected. The antenna subsets can be selected by reducing or minimizing one or more selected worst-case conditions relating to the communication. Letting I ε {0,1}N^{N}^{ₜ} be a binary sequence and I_{I} denote the Nₜ×Nₜ identity matrix with only the columns corresponding to the indices of nonzero entries of I remaining, then the indices of the selected transmit antennas can be provided as the indices of nonzero entries of Iₜ according to expression (19) as follows:

$${ℐ}_{t} = {argmin}_{\vert ℐ \vert = D} cond ( {\sum }_{j} {𝒥}_{t , j} {I}_{ℐ} {A}_{t , j} {I}_{ℐ} ) \qquad ( 19 )$$

The selected subset depends on the physical channel through the binary sequence ℑₜ which has 2^{N}^{ₜ} possible values. This quantity is significantly less than standard approaches based on the possible correlation matrices. The 2^{N}^{ₜ} subsets can be pre-computed for each D and stored in memory 52a and/or 52b to avoid any significant real-time computation. When available memory is limited, a further approximation results from basing subset selection on the total angle spread |ℑₜ| rather than ℑₜ. For this total angle spread technique, memory usage is a function of Nₜ as compared to 2^{N}^{ₜ} if based on the ℑₜ sequence technique. Accordingly, a selected subset can be determined in accordance with expression (20) as follows:

$${ℐ}_{t} = {argmin}_{\vert ℐ \vert = D} {max}_{\vert 𝒥 \vert = \vert {𝒥}_{t} \vert} cond ( {\sum }_{j} {𝒥}_{j} {I}_{ℐ} {A}_{t , j} {I}_{ℐ} ) \qquad ( 20 )$$

### In correspondence to antenna subset determination for transmission, the antenna subset determination for the receive antennas is found by reducing or minimizing one or more worst-case conditions for the receive signal space, and is denoted by Iᵣ.

To estimate the angular spectrum Ĝ_{h,ij} as a function of the vector sets {vⱼₘ} and {uᵢₙ}. The estimator for angular spectrum is given by expression (21) as follows:

$${\hat{G}}_{h , ij} = \frac{1}{{N}_{l} {L}_{r , i} {L}_{t , j}} {\sum }_{l = 1}^{{N}_{l}} {\sum }_{n = 1}^{{L}_{r , i}} {\sum }_{m = 1}^{{L}_{t , j}} {\vert {u}_{i n}^{†} {H}_{l} {v}_{jm} \vert}^{2} \qquad ( 21 )$$

The vector sets {vⱼₘ} and {uᵢₙ} are selected to minimize bias of this estimator, and equivalently can be considered spatial filters. The radiation pattern generated by the transmission of {vⱼₘ} is represented by Vⱼₘ (\hat{k}) and the reception pattern corresponding to {uᵢₙ} is represented by Uᵢₙ (\hat{κ}) from which expressions (22) follow for all m and n:

Vⱼₘ(\hat{k}):=aₜ^{†}(\hat{k})vⱼₘ Uᵢₙ(\hat{κ}):=aᵣ^{†}(\hat{κ})uᵢₙ (22)

The sets of radiation patterns and reception patterns are further constrained to be individually orthonormal over the respective transmit and receive propagation spaces for which expressions (23) follow:

$${\int }_{{Ω}_{t}^{full}}^{ } {V}_{jm} ( \hat{k} ) {V}_{{jm}^{′}}^{*} ( \hat{k} ) d \hat{k} = {δ}_{m {m}^{′}} \\ {\int }_{{Ω}_{r}^{full}}^{ } {U}_{i n} ( \hat{κ} ) {U}_{i {n}^{′}}^{*} ( \hat{κ} ) d \hat{κ} = {δ}_{{nn}^{′}} \qquad ( 23 )$$

### The spatial filters {vⱼₘ} and {uᵢₙ} are obtained by minimizing the bias of the angular spectrum estimator as follows in expressions (24a)-(24c):

$$\begin{matrix}bias \text{:} = {E}_{h} [ {\hat{G}}_{h , ij} ] - {G}_{h , ij} & ( 24 a ) \\ = \frac{1}{{L}_{r , i} {L}_{t , j}} {\sum }_{n = 1}^{{L}_{r , i}} {\sum }_{m = 1}^{{L}_{t , j}} \int \int {\vert {U}_{i n} ( \hat{κ} ) \vert}^{2} {G}_{h} ( \hat{κ} , \hat{k} ) {\vert {V}_{jm} ( \hat{k} ) \vert}^{2} d \hat{κ} d \hat{k} - & \\ \frac{1}{\vert {C}_{t , j} \vert \vert {C}_{r , i} \vert} {\int }_{{C}_{t , j}}^{ } {\int }_{{C}_{r , i}}^{ } {G}_{h} ( \hat{κ} , \hat{k} ) d \hat{κ} d \hat{k} & ( 24 b ) \\ = \frac{1}{{L}_{r , i} {L}_{t , j}} {\sum }_{n = 1}^{{L}_{r , i}} {\sum }_{m = 1}^{{L}_{t , j}} {\int }_{{C}_{t , j}}^{ } {\int }_{{C}_{r , i}}^{ } [ {\vert {U}_{i n} ( \hat{κ} ) \vert}^{2} {\vert {V}_{jm} ( \hat{k} ) \vert}^{2} - & \\ \frac{1}{\vert {C}_{t , j} \vert \vert {C}_{r , i} \vert} ] {G}_{h} ( \hat{κ} , \hat{k} ) d \hat{κ} d \hat{k} + & \\ \frac{1}{{L}_{r , i} {L}_{t , j}} {\sum }_{n = 1}^{{L}_{r , i}} {\sum }_{m = 1}^{{L}_{t , j}} {\int }_{{Ω}_{t}^{full} ⋂ {C}_{t , j}^{c}}^{ } {\int }_{{Ω}_{r}^{full} ⋂ {C}_{r , i}^{c}}^{ } & ( 24 c ) \\ {\vert {U}_{i n} ( \hat{κ} ) \vert}^{2} {G}_{h} ( \hat{κ} , \hat{k} ) {\vert {V}_{jm} ( \hat{k} ) \vert}^{2} d \hat{κ} d \hat{k} & \end{matrix}$$

The bias is zero if Gₕ (\hat{κ}, \hat{k}) is flat over the transmit and receive propagation spaces. The bias at worst-case if Gₕ (\hat{κ}, \hat{k}) is flat and nonzero only over the cells C_{r,i}×C_{t,j}. To minimize this worst-case bias, spatial filters {vⱼₘ} and {uᵢₙ} are determined according to expression (25a) and (25b):

$$\begin{matrix}{bias}_{worst} = \frac{1}{{L}_{r , i} {L}_{t , j}} {\sum }_{n = 1}^{{L}_{r , i}} {\sum }_{m = 1}^{{L}_{t , j}} {\int }_{{C}_{t , j}}^{ } {\int }_{{C}_{r , i}}^{ } {\vert {U}_{i n} ( \hat{κ} ) \vert}^{2} {\vert {V}_{jm} ( \hat{k} ) \vert}^{2} - & ( 25 a ) \\ \frac{1}{\vert {C}_{t , j} \vert \vert {C}_{r , i} \vert} d \hat{κ} d \hat{k} & \\ = \frac{1}{{L}_{r , i}} {\sum }_{n = 1}^{{L}_{r , i}} {\int }_{{C}_{r , i}}^{ } {\vert {U}_{i n} ( \hat{κ} ) \vert}^{2} d \hat{κ} \cdot \frac{1}{{L}_{t , j}} {\sum }_{m = 1}^{{L}_{t , j}} & ( 25 b ) \\ {\int }_{{C}_{t , j}}^{ } {\vert {V}_{jm} ( \hat{k} ) \vert}^{2} d \hat{k} - 1 & \end{matrix}$$

Expression (25a) and (25b) are equivalent to the solutions to the optimization problems represented by expressions (26a) and (26b) as follows:

$$\begin{matrix}maximize {\sum }_{m = 1}^{{L}_{t , j}} {\int }_{{C}_{t , j}}^{ } {\vert {V}_{jm} ( \hat{k} ) \vert}^{2} d \hat{k} \\ subject to {\int }_{{Ω}_{t}^{full}}^{ } {V}_{jm} ( \hat{k} ) {V}_{{jm}^{′}}^{*} ( \hat{k} ) d \hat{k} = {δ}_{m {m}^{′}} & ( 26 a ) \\ maximize {\sum }_{n = 1}^{{L}_{r , i}} {\vert {U}_{i n} ( \hat{κ} ) \vert}^{2} d \hat{κ} \\ subject to {\int }_{{Ω}_{r}^{full}}^{ } {U}_{i n} ( \hat{κ} ) {U}_{i {n}^{′}}^{*} ( \hat{κ} ) d \hat{k} = {δ}_{{nn}^{′}} & ( 26 b )\end{matrix}$$

### The solution to expression (26a) is the set of generalized eigenvectors corresponding to the L_{t,j} largest generalized eigenvalues given by expression (27):

Aₜ(C_{t,j})vⱼₘ=λⱼₘAₜ(Ωₜ^{full})vⱼₘ (27)

which is equivalent to solving expression (28) as follows:

$${A}_{t , j} {v}_{jm} = {λ}_{jm} ( {\sum }_{{j}^{′}} {A}_{t , {j}^{′}} ) {v}_{jm} \qquad ( 28 )$$

where λⱼₘ represent the mth generalized eigenvalues. The solution to expression (26b) is the set of generalized eigenvectors corresponding to the L_{r,i} largest generalized eigenvalues given by expression (29):

$${A}_{r , i} {u}_{i n} = {σ}_{i n} ( {\sum }_{{i}^{′}} {A}_{r , {i}^{′}} ) {u}_{i n} \qquad ( 29 )$$

where σᵢₙ represent the nth generalized eigenvalues. Expression (30) refines the estimator to account for additive noise as follows:

$$\begin{matrix}{\hat{G}}_{h , ij} = \frac{1}{{N}_{l} {L}_{r , i} {L}_{t , j}} {\sum }_{l = 1}^{{N}_{l}} {\sum }_{n = 1}^{{L}_{r , i}} {\sum }_{m = 1}^{{L}_{t , j}} [ \vert {u}_{i n}^{†} {H}_{l} {v}_{jm} + \\ { \frac{{ρ}_{jm}}{\sqrt{SNR}} {u}_{i n}^{†} {z}_{ljm} \vert}^{2} - \frac{{ρ}_{jm}^{2}}{SNR} {‖ {u}_{i n} ‖}^{2} ]\end{matrix} \\ where \\ {ρ}_{jm}^{2} = {‖ {v}_{jm} ‖}^{2} \int \int \int P ( t , \hat{κ} , \hat{k} ) d t d \hat{κ} d \hat{k} and {z}_{ljm} ’ s \qquad ( 30 )$$

correspond to the additive noise. Equivalently, the set of training symbols {vⱼₘ: m=1, . . . , L_{t,j}} are sent sequentially, the received signal is projected onto {uᵢₙ: n=1, . . . , L_{r,i}}, and the noise energy is subtracted from the energy of the projected signal. Summing over all the differences yields the spectrum estimate.

It should be appreciated that the angular spectrum estimator Ĝ_{h,ij} is robust to different antenna array configurations. First considering a uniform linear array, it should be understood that there is a corresponding uniform angular resolution. For this case, the array manifold can be represented by the discrete-time Fourier transform, which in turn can be represented in the angular domain in terms of samples taken at uniformly spaced directions, as denoted by \hat{k}ᵢ, i=1, . . . Nₜ at the transmitter and \hat{κ}ᵢ, i=1, . . . , Nᵣ at the receiver, with the spacing between these directions chosen such that: {aₜ(\hat{k}ᵢ): i=1, . . . , Nₜ} and {aᵣ(\hat{k}ᵢ): i=1, . . . , Nᵣ} are orthogonal sets. The transmit and receive array manifolds are defined in terms of the respective sets of generalized eigenvectors as follows in expressions (31):

v={vⱼₘ: j=1, . . . , Nₜ and m=1, . . . , L_{t,i}}

u={uᵢₙ: i=1, . . . , Nᵣ and n=1, . . . , L_{r,i}} (31)

The number of vectors in V can be larger than Nₜ and the number of vectors in U can be larger than Nᵣ to ensure that the dimension of the span of V is Nₜ and that of U is Nᵣ. As a result, the choice of resolving cells {C_{r,i}} and {C_{t,j}} can be arbitrary, and therefore the angular spectrum estimator is robust to arbitrary array configurations. In one form, desired choices would be those that correspond to expressions (32) and (33) as follows:

L_{t,1}= . . . =L_{t,N}_{ₜ}=1 L_{r,1}= . . . =L_{r,N}_{ᵣ}=1 (32)

λ₁₁≈ . . . ≈λ_{N}_{ₜ}₁ σ₁₁≈ . . . ≈σ_{N}_{ᵣ}₁ (33)

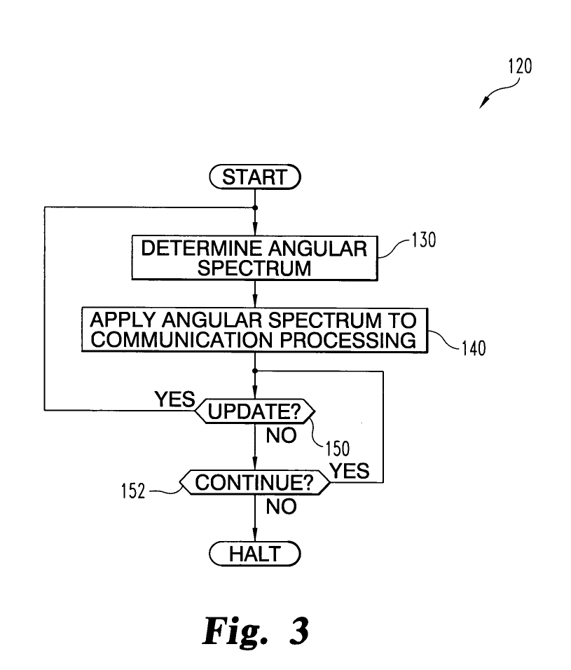

With this modeling in mind, communication processing procedure 120 is next described as represented by flowchart in FIG. 3. Procedure 120 is at least partially implemented with system 20 having various computations performed by operating logic of processing circuitry 50a and 50b. Procedure 120 begins with operation 130 which determines the angular spectrum for system 20 in accordance with expression (21). From the determination of the angular spectrum in operation 130, procedure 120 continues with operation 140. In operation 140, one or more processing applications are performed as a function of the angular spectrum provided in operation 130. After operation 140, conditional 150 executes, which tests whether to perform an update of the angular spectrum determination. If conditional 150 is affirmative (true), procedure 120 returns to repeat operations 130 and 140. If conditional 150 is negative (false), procedure 120 continues with conditional 152, which tests whether to continue procedure 120. If the test of conditional 152 is affirmative (true), procedure 120 loops back to repeat conditional 150. If the test of conditional 152 is negative, procedure 120 halts. It should be appreciated that operation 140 can be performed in parallel with operation 130 and/or conditional 150, utilizing updated angular spectrum estimations as they become available. In still other embodiments, updating may not be desired, and/or a different implementation may be utilized.

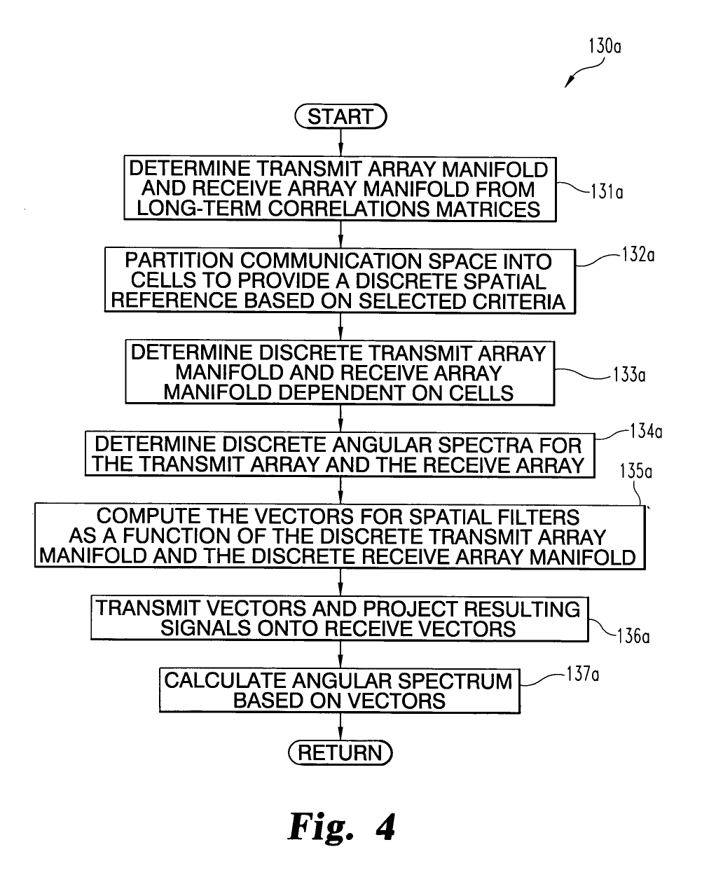

One form of operation 130 is further described in connection with angular spectrum estimation routine 130a depicted by flowchart in FIG. 4. Routine 130a begins with estimation of the transmit array manifold aₜ (\hat{k}) and receive array manifold aᵣ (\hat{κ}) in operation 131a. As described in connection with expressions (8a) and (8b), transmit and receive array manifolds can be estimated a priori at the transmitter and receiver, respectively, from the corresponding long-term correlation matrices. These manifolds are inputs to subsequent operations. Routine 130a proceeds with operation 132a. In operation 132a, the communication space is partitioned into sets of resolving cells for the transmit space {C_{t,j}} and the receive space {C_{r,i}}. In one form, selection of these cells is performed so that corresponding L_{t,j} and L_{r,i} values are close to unity and/or λⱼₘ and σᵢₙ generalized eigenvalues are individually close to one another in value. Next, in operation 133a, the discrete transmit array manifold A_{t,j} and the discrete receive array manifold A_{r,i} are determined as a function of the corresponding manifolds aₜ (\hat{k}), aᵣ (\hat{κ}), and the cells {C_{t,j}} and {C_{r,i}} per expressions (12). From operation 133a, routine 130a continues with operation 134a. In operation 134a, the discrete angular spectra for the transmit array and the receive array are determines as represented by G_{t,j} and G_{r,i}, respectively. This determination can be provided as an a priori estimate from the long-term correlation as described in connection with expression (13). From operation 134a, routine 130a proceeds with operation 135a. In operation 135a, the spatial filter vectors {vⱼₘ} (where {vⱼₘ ε C^{N}^{ₜ}: m=1, . . . , L_{t,j}}) and {uᵢₙ} (where {uᵢₙ ε C^{Nr}^{ᵣ}: n=1, . . . , L_{r,i}}) are computed in accordance with expressions (28) and (29), {A_{t,j}}, {A_{r,i}}, {L_{t,j}}, and {Lᵣᵢᵢ} as inputs. It should be appreciated that operations 131a-135a can be performed with little or no real-time calculation overhead.

Routine 130a proceeds from the a priori operations 131a-135a to real-time processing operations 136a and 137a. Operation 136a utilizes the computed values of vectors {vⱼₘ} and {uᵢₙ} as inputs. For each j ε {1, . . . , Nₜ} and each m ε {1, . . . , L_{t,j}}; the corresponding vector vⱼₘ is sent from transmitter 30a to receiver 30b and the received signal is projected at subcarrier l, yⱼₘₗ onto the vectors uᵢₙ; where rᵢⱼₘₙₗ=uᵢₙ^{†}yⱼₘₗ, ∀i,n,l. The angular spectrum summation expression (21) correspondingly can be represented with expression (34) as follows:

$${\hat{G}}_{h , ij} = \frac{1}{{L}_{t , j} {L}_{r , i} {N}_{t}} {\sum }_{mnl}^{ } {\vert {r}_{ijmnl} \vert}^{2} , ∀ i .$$

The angular spectrum is computed in operation 137a according to expression (34). A pseudo-code form of operations 136 and 137a is provided as follows:

| | |
|---|---|
| Spectrum | Inputs: {vⱼₘ} and {uᵢₙ} |
| estimation | For each j ∈ {1, ..., Nₜ}, |
| | $For each m ∈ \{ 1 , … , {N}_{t} \} , \\ Transmit {v}_{jm} . \\ Project receive signal at subcarrier l , {y}_{jml} , onto {u}_{in} ' s : \\ {r}_{ijmnl} = {u}_{in}^{†} {y}_{jml} , ∀ i , n , l . \\ Compute {\hat{G}}_{h , ij} = \frac{1}{{L}_{t , j} {L}_{r , i} {N}_{l}} {\sum }_{mnl} {\vert {r}_{ijmnl} \vert}^{2} , ∀ i .$ |

Returning to FIG. 3, in operation 140 there are several applications of the angular spectrum estimate from operation 130, a few of which are further described in connection with FIGS. 5-7. Referring specifically to FIG. 5, antenna selection routine 140a is further described. Routine 140a begins with operation 141a. In operation 141a, the discrete transmit array manifold A_{t,j} and the discrete receive array manifold A_{r,i} are utilized as input, being determined as a function of the manifolds aₜ (\hat{k}), aᵣ (\hat{κ}), and the cells {C_{t,j} {C}_{r,i}} per expressions (12) during the execution of routine 130a. With these inputs, memory 52a of transmitter 30a and memory 52b of receiver 30b are each loaded with indexed entries of [D][n] corresponding to different antenna configurations as a function of the discrete angle spread \hat{ℑ} per expression (20); where D ε {1, . . . , min{Nₜ, Nᵣ}} and n ε {1, . . . , Nₜ} . In one form, this loading is implemented in accordance with the following psuedocode description:

| | |
|---|---|
| Antenna selection | Inputs:- {A_{t,j}}, {A_{r,i}} |
| | $for each D ∈ \{ 1 , … , min \{ {N}_{t1} {N}_{t} \} \} , \\ for each n ∈ \{ 1 , … , {N}_{t} \} , \\ {memory}_{tx} [ D ] [ n ] = {argmin}_{\vert ℐ \vert = D} {max}_{\vert 𝒥 \vert = n} cond ( {\sum }_{j} {𝒥}_{j} {I}_{ℐ} {A}_{t , j} {I}_{ℐ} )$ |
| | $for each n ∈ \{ 1 , … , {N}_{r} \} , \\ {memory}_{r x} [ D ] [ n ] = {argmin}_{\vert ℐ \vert = D} {max}_{\vert 𝒥 \vert = n} cond ( {\sum }_{i} {𝒥}_{i} {I}_{ℐ} {A}_{r , i} {I}_{ℐ} )$ |

where: memoryₜₓ and memoryᵣₓ correspond to indexed tables in memories 52a and 52b, respectively. This operation can be performed a priori, before real-time processing commences. The minimization of the worst-case condition in expression (20) is designated by the “argmin max cond” operator. The condition selected for this operation can vary for the particular application. In one form, the condition of worst-case symbol error is minimized in expression (20). In another form, the condition is based on the desire to maximize channel capacity. In still other forms, a different condition may be selected.

Accordingly, a given antenna transmit or receive configuration can be specified by generating an index pointer to the table in memory 52a or 52b, respectively. The contents for the table entry in turn provide indices to the antenna elements 32 to use for the corresponding array 32a or 32b, respectively. The remaining operations 142a-146a of routine 140a are preformed as a real-time process to select desired receive and transmit antenna configurations based-on real-time conditions. In addition to the configuration indexed memory 52a and memory 52b, other inputs to these real-time operations include the angular spectrum {Ĝ_{h,ij}}, and the transmit and receive spectra {G_{t,j}} and {G_{r,i}} from routine 130a. In operation 142a, the total receive and transmit angle spreads, |\hat{ℑ}ₜ|, and |\hat{ℑ}ᵣ| are determined at receiver 30b in accordance with expression (16) and selection of a desired threshold ⊖ₜₕ. Routine 140a continues with operation 143a. In operation 143a, \hat{D} (discrete form of the minimum signal space dimension D) is found as the minimum of the total angle spreads, \hat{D}=min{|\hat{ℑ}ₜ|, |\hat{ℑ}ᵣ|}. In operation 144a, the resulting value for \hat{D} is used in conjunction with the total receive angle spread |\hat{ℑ}ᵣ|, to collectively provide a pointer [\hat{D}][|\hat{ℑ}ᵣ|] to the receiver memory table entry of memory 52b with the appropriate array 32b configuration indices. In operation 145a, receiver 30b then sends \hat{D} and the total transmit angle spread |\hat{ℑ}ₜ| to transmitter 30a, which typically is performed with a transmitter of device 21b (not shown). Routine 140a continues with operation 146a. In operation 146a, transmitter 30a collectively utilizes [\hat{D}][|\hat{ℑ}ₜ|] to point to the transmitter memory table entry of memory 52a with the appropriate array 32a configuration indices. Procedure 130a then returns. In one form, the real-time selection operations 142a-146a are performed in accordance with the following psuedocode:

| | |
|---|---|
| Antenna | $Input : \{ {\hat{G}}_{h , ij} \} , \{ {G}_{t , j} \} , \{ {G}_{r , i} \} , {memory}_{tx} , {memory}_{rx}$ |
| selection | $At {receiver}_{i} compute$ ${\hat{G}}_{h , j}^{t} = {\sum }_{i} {\hat{G}}_{h , ij} {G}_{r , i} and \vert {\hat{𝒥}}_{t} \vert = {\sum }_{j} 1 ( {\hat{G}}_{h , j}^{t} > \frac{1}{2} max \{ {\hat{G}}_{h , j}^{t} \} )$ ${\hat{G}}_{h , i}^{r} = {\sum }_{i} {\hat{G}}_{h , ij} {G}_{t , j} and \vert {\hat{𝒥}}_{r} \vert = {\sum }_{i} 1 ( {\hat{G}}_{h , i}^{r} > \frac{1}{2} max \{ {\hat{G}}_{h , i}^{r} \} )$ $\hat{D} = min \{ \vert {\hat{𝒥}}_{t} \vert , \vert {\hat{𝒥}}_{r} \vert \} . \\ Point to {memory}_{rx} [ \hat{D} ] [ \vert {\hat{𝒥}}_{r} \vert ] for indices of selected antennas . \\ Send \hat{D} and \vert {\hat{𝒥}}_{t} \vert back to the transmitter . \\ Point to {memory}_{tx} [ \hat{D} ] [ \vert {\hat{𝒥}}_{t} \vert ] for indices of selected antennas .$ |

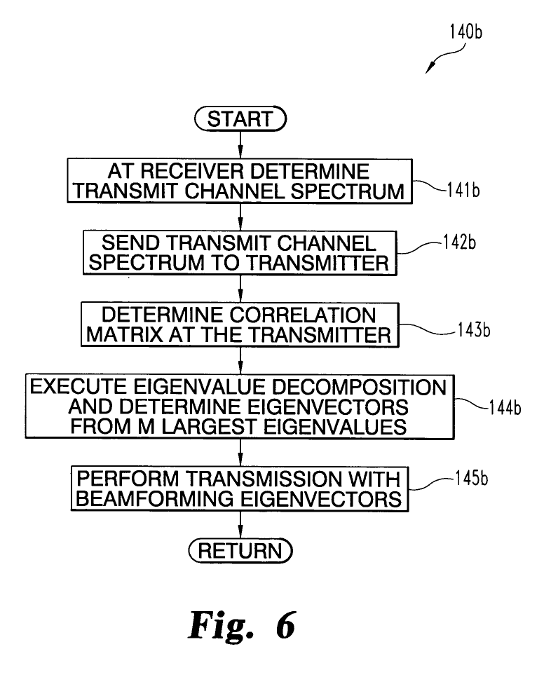

FIG. 6 depicts a transmission beamforming routine 140b that utilizes the discrete form of angular spectra {Ĝ_{h,ij}}, the receive spectra {G_{r,i}}, and transmit array manifold {A_{t,j}} from routine 130a. Routine 140b begins with operation 141b, in which receiver 30b determines the discrete transmit channel spectrum Ĝ_{h,j}^{t} in accordance with

$${\hat{G}}_{h , j}^{t} = {\sum }_{i} {\hat{G}}_{h , ij} {G}_{r , i} , ∀ j .$$

In operation 142b, the transmit channel spectrum determined in operation 141b is sent to transmitter 30a, which is typically performed with a transmitter included in device 21b (not shown). At transmitter 30a, the short-term transmit correlation matrix Rₜ is determined in accordance with expression (15) through operation 143b of routine 140b

$$( {R}_{t} = {\sum }_{j} {G}_{h , j}^{t} {A}_{t , j} ) .$$

Routine 140b proceeds to operation 144b. In operation 144b, transmitter 30a performs eigenvector decomposition of the transmit correlation matrix Rₜ to determine the eigenvectors corresponding to the M largest eigenvalues. In operation 145b of routine 140b, transmit beamforming is performed with the eigenvectors of operation 144b.

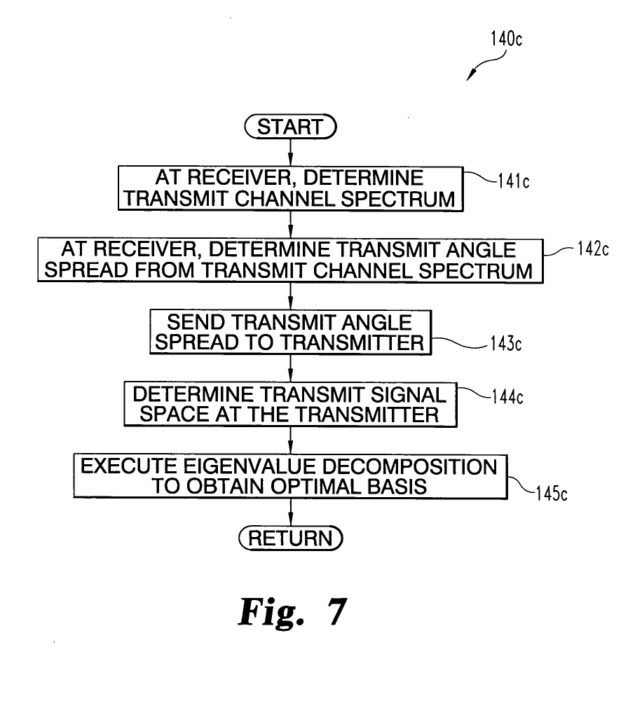

FIG. 7 depicts a signal space estimation routine 140c that utilizes the discrete form of angular spectrum {Ĝ_{h,ij}}, the receive spectra {G_{r,i}}, and transmit array manifold {A_{t,j}} from routine 130a. Routine 140c begins with operation 141c, in which receiver 30b determines the discrete transmit channel spectrum Ĝ_{h,j}^{t} in accordance with

$${\hat{G}}_{h , i}^{t} = {\sum }_{i} {\hat{G}}_{h , ij} {G}_{r , i} , ∀ j ,$$

which is used to determined the transmit angle spread \hat{ℑ}ₜ in accordance with \hat{ℑ}_{t,j}=1(G_{h,j}^{t}>½max{G_{h,j}^{t}}),∀j. In operation 142c, the transmit angle spread \hat{ℑ}ₜ determined in operation 141c is sent to transmitter 30a, which is typically performed with a transmitter included in device 21b (not shown). At transmitter 30a, the transmit signal space is estimated in accordance with a discrete form of expression (17), as given by

$${\sum }_{j} {\hat{}}_{t , j} {A}_{t , j}$$

in operation 144c. From operation 144c, routine 140c proceeds to operation 145c. In operation 145c, eigenvalue decomposition is preformed to provide an optimal basis for transmitter operation. From operation 145c, routine 140c returns.

As previously described, after operation 140 is completed, procedure 120 tests whether to perform updates and whether to continue processing as represented by conditionals 150 and 152, respectively. In a typical MIMO application, it is anticipated that updates would be performed from time-to-time on periodic or aperiodic intervals, with processing feedback from receiver 30b to transmitter 30a as exemplified in operations 145a, 142b, and 143c for routines 140a, 140b, and 140c, respectively. In other embodiments, different applications may alternatively or additionally be performed in operation 140 that may or may not depend on angular spectrum from operation 130. Also, further embodiments may include more or fewer applications in operation 140.

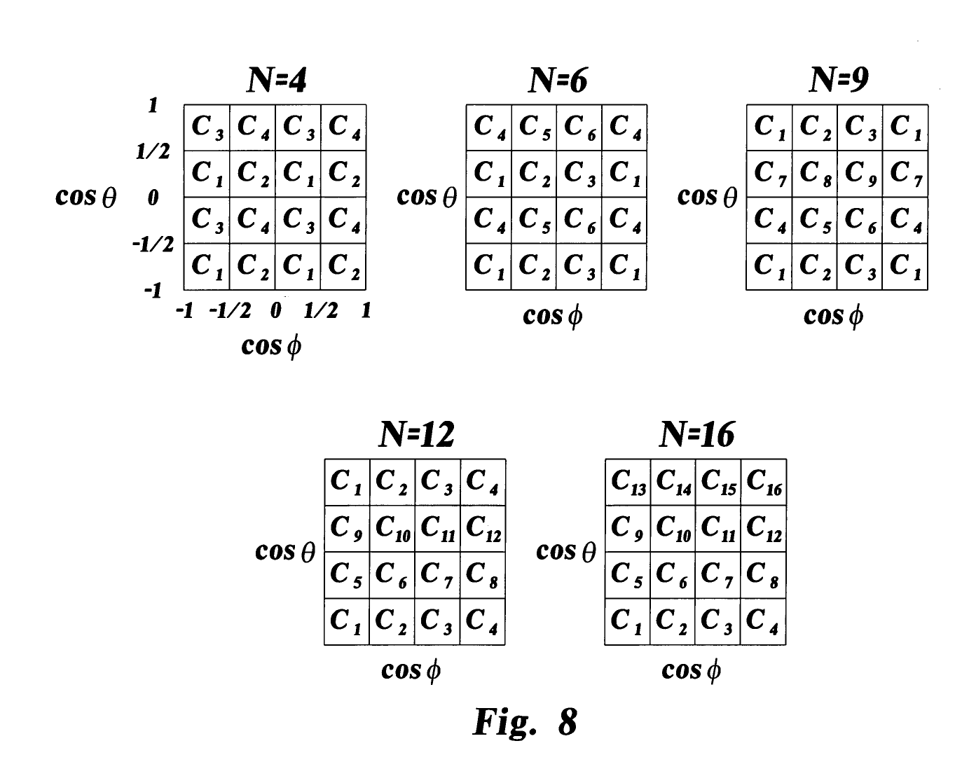

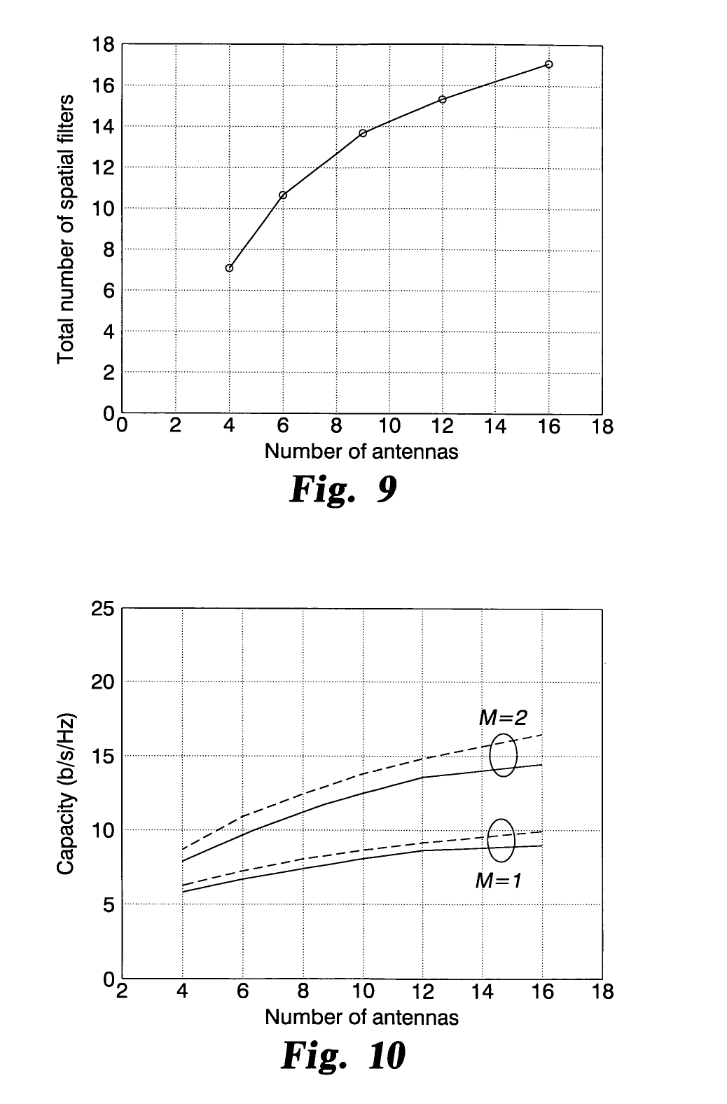

Referring to FIG. 8, a few representative numerical examples are described. Transmit and receive arrays 32a and 32b are considered that have the same aperture of 2λ×2λ; where λ is the carrier wavelength. For example, the aperture area corresponds to 12×12 cm² at 5.2 GHz and 25×25 cm² at 2.4 GHz. For this aperture dimension, if antennas were uniformly placed with half-wavelength spacing, the number of antennas desired in this example would be 16. Considering the antennas being randomly placed on the aperture, antenna systems with 4, 6, 9, 12, and 16 number of antennas are investigated. The entire (full) transmit angular region and receive angular region are the same with elevation direction θ covering [30°, 150°) and azimuth direction o covering [0°, 180°]. Both full transmit and receive angular regions are partitioned according to FIG. 8. FIG. 8 illustrates the partition of the propagation space into N non-overlapping cells, I, (i=1, . . . , N); where N is the number of antenna elements. The number of antennas N is first factorized into a product of N_{θ} and Nø which denote the numbers of resolving cells along the cos θ-axis and the cos ø-axis respectively. In the example systems, (N, N_{θ}, Nø) takes the value of (4, 2, 2), (6, 2, 3), (9, 3, 3), (12, 3, 4), and (16, 4, 4). Because the azimuth direction has a larger range than the elevation, the resolution over the cos θ-axis is better than the cos θ-axis. Each resolving cell, Cᵢ, can contain multiple disjoint intervals. For instances, each resolving cell in the 4-element array contains 4 disjoint intervals each corresponding to the cell C₁ locations. Each disjoint interval will have width equal to (A)^{-1/2} along the cos θ-axis as well as the cos ø-axis, where A is the aperture area normalized to a square wavelength and (A)^{-1/2} equals ½ in the example systems. The total number of spatial filters average over 1×10⁴ realizations of antenna arrays is plotted in FIG. 9 for the different antenna systems in correspondence to the resolving cells of FIG. 8. The partition full transmit and receive angular regions are in close proximity to the criteria set forth in expressions (32) and (33).

For the channel, both Ωₜ and Ωᵣ are composed of 3 clusters randomly placed. Each cluster has an azimuth spread of 30° and elevation spread of 15°, inferred from indoor channel measurements. Two different delay spreads T_{d} are considered: 5-tap versus 10-tap. The channel power profile is flat over [0, T_{d})×Ωᵣ and Ωₜ, as represented by the following expression (35):

$$P ( t , \hat{κ} , \hat{k} ) = \{ \begin{matrix}1 , & ( t , \hat{κ} , \hat{k} ) ∈ [ 0 , {T}_{d} ) \times {Ω}_{r} \times {Ω}_{f} \\ 0 , & otherwise .\end{matrix} \qquad ( 35 )$$

### The signal-to-signal ratio (SNR) on each receive antenna is 10 deciBels (SNR=10 dB).

For each simulation, the number of transmit and the number of receive antennas are the same. For each N (=Nₜ, Nᵣ), 100 realizations of different transmit and receive arrays are generated. For each realization of antenna arrays, the spatial filters are computed according to operation 135a and expressions (28) and (29), and generate 100 realizations of channel responses. For each realization of channel response, the angular spectrum is estimated according to routine 130a. From which, the transmit beamforming vectors for M=1, 2, the transmit signal space, and the subsets of selected antennas are determined per routines 140b, 140c, and 140a; respectively. Simulation results are further described as follows:
Transmit beamforming. Suppose \hat{q}ᵢ, i=1,2 are the first two eigenvectors of the estimated transmit correlation matrix and \hat{Q}=[\hat{q}₁, \hat{q}₂]. Then, the ergodic capacity assuming equal power allocation is given by expression (36) as follows:

$${C}_{bf} = \{ \begin{matrix}{\sum }_{l} {log}_{2} det ( I - \frac{SNR}{\int \int \int P ( t , \hat{κ} , \hat{k} ) d t d \hat{κ} d \hat{k}} {\hat{q}}_{1}^{†} {H}_{l}^{†} {H}_{l} {\hat{q}}_{1} ) , & M = 1 \\ {\sum }_{l} {log}_{2} det ( I - \frac{SNR}{2 \int \int \int P ( t , \hat{κ} , \hat{k} ) d t d \hat{κ} d \hat{k}} {\hat{Q}}_{ }^{†} {H}_{l}^{†} {H}_{l} \hat{Q} ) , & M = 2\end{matrix} \qquad ( 36 )$$

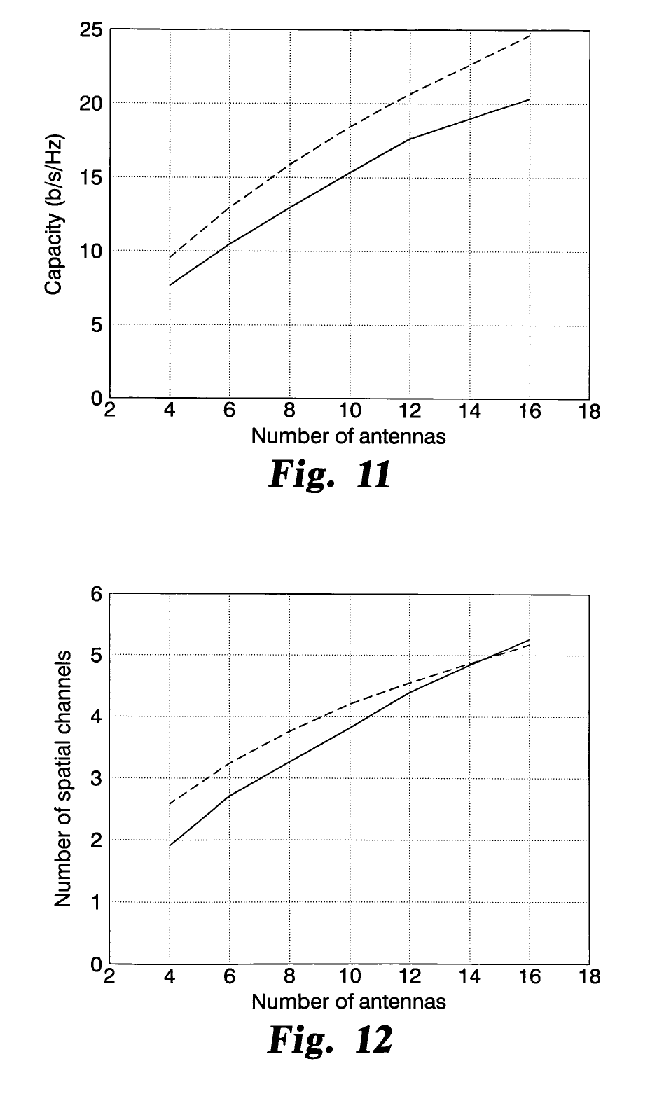

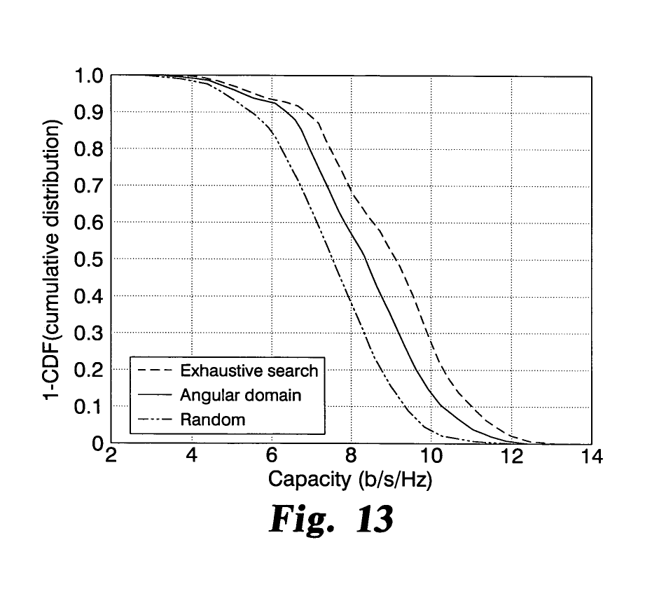

FIG. 10 plots the capacity average for transmit beamforming over the 1×10⁴ realizations versus the number of antennas. The dotted lines in the graph of FIG. 10 are from beamforming vectors computed directly from Rₜ.
Transmit signal space estimation. The average capacity assuming equal power allocation over the estimated transmit signal space is plotted in FIG. 11. The dotted line is the “waterfilling capacity” assuming known instantaneous channel response at both transmitter and receiver. The corresponding number of spatial channels is plotted in FIG. 12. The FIG. 12 graph shows that the estimated total angle spread in the discrete representation tracks the dimension of the signal space.
Antenna selection. The capacity for the antenna system using the blind selected subsets of antennas is computed for each realization. The cumulative capacity distribution (CCD) over all realizations is plotted in FIG. 13 for N=12. The lower curve in the graph of FIG. 13 corresponds to randomly selecting the same number of antennas and therefore does not require any computation.
   All results shown are for the 5-tap delay spread channels. Similar results were obtained for the 10-tap delay spread channels and therefore are not repeated herein.

Many further embodiments of the present invention are envisioned. For example, in certain alternatives, only a transmitter or receiver may be utilized in lieu of a transceiver arrangement. In such cases, information exchanged between the devices may occur by other than a wireless communication route, such as a wired connection or the like. In another example, a technique of the present application includes: operating a device including several antenna elements, specifying a number of different subsets of the antenna elements in the device, determining one or more values representative of angle spread for multiple wireless communication paths with the device, selecting one of the different subsets of the antenna elements based on the one or more values representative of the angle spread, and wirelessly communicating the one of the different subsets of the antennas.

In still another embodiment, a device includes several antenna elements, and further includes: means for specifying a number of different subsets of the antenna elements in the device, means for determining one or more values representative of angle spread for multiple wireless communication paths, means for selecting one of the different subsets of the antenna elements based on the one or more values representative of the angle spread, and means for wirelessly communicating with the one of the different subsets of the antennas.

A further example is directed to an apparatus that comprises: an antenna array including a first number of antenna elements; a second number of analog RF circuits that is less than the first number of antenna elements, processing circuitry including a memory to store information representative of a plurality of a different subsets of the antenna elements, and a routing circuit coupled between the antenna elements and the analog RF circuits. The analog RF circuits are each operable to perform RF analog front-end transformation of a respective one of the corresponding number of communication signal streams. The processing circuitry is operable to determine one or more values representative of an angle spread for multiple wireless communication paths select one of the different subsets based on the one or more values, and generate one or more output signals corresponding to the one or more different subsets of the antenna elements. The routing circuit is responsive to the one or more output signals to connect each element in the one of the different subsets of the antenna elements to a different one of the analog RF circuits.

Still a further example is directed to a system that comprises: a first wireless communication device including a number of first device antenna elements, a first device receiver, first device processing circuitry, and a first device transmitter. Also included is a second communication device with a number of second device antenna elements, a second device receiver, a second device processing circuitry to determine angular domain transmission information as a function of an angular spectrum, and a second device transmitter to send the angular domain transmission information to the first device receiver. The first device processing circuitry controls transmission from the first device transmitter in accordance with the angular domain transmission information.

Another example includes: sending a number of transmit vectors from a first wireless communication device to a second wireless communication device, where each of these devices includes multiple antennas suitable for MIMO operation; determining a number of receive vectors with the second wireless communication device in response to the transmit vectors; determining a representation of angular spectrums for wireless communication between the first device and the second device as a function of the transmit vectors and the receive vectors; and controlling a multiple antenna output transmission of at least one of the first device and the second device in accordance with the representation of angular spectrum.

A further example includes a first multiple antenna wireless communication device and a second multiple antenna wireless communication device. The first wireless communication device includes means for sending a number of transmit vectors to the second wireless communication device. The second device includes means for determining a number of receive vectors in response to the transmit vectors from the first device. At least one of the first device and the second device includes means for determining a representation of angular spectrum for wireless communication between the first device and the second device as a function of the transmit and receive vectors. Also, one or more of the first device and the second device includes means for controlling a multiple antenna output transmission in accordance with the representation of angular spectrum.

Yet another example includes with a first multiple antenna wireless communication device, determining an angular domain representation of a transmit channel spectrum for a second multiple antenna wireless communication device; transmitting the angular domain representation from the first multiple antenna wireless communication device to the second multiple antenna wireless communication device; and controlling a transmission from the second multiple antenna wireless communication device to the first multiple antenna wireless communication device as a function of the angular domain representation. Still another example is directed to a system comprising a first multiple antenna wireless communication device and a second multiple antenna wireless communication device. The first device includes means for determining an angular domain representation of a transmit channel spectrum for the second device and means for transmitting the angular domain representation from the first device to the second device. The second device includes means for controlling a transmission to the first device as a function of the angular domain representation.

Still a further example is directed to a system, comprising: a first wireless communication device including a number of first device antenna elements, a first device receiver, first device processing circuitry, and a first device transmitter; and a second communication device including a number of second device antenna elements, a second device receiver, second device processing circuitry to determine angular domain transmission information as a function of an angular spectrum, and a second device transmitter to send the angular domain transmission information to the first device receiver, the first device processing circuitry controlling transmission from the first device transmitter in accordance with the angular domain transmission information.

Any theory, mechanism of operation, proof, or finding stated herein is meant to further enhance understanding of the present invention and is not intended to make the present invention in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow. In reading the claims it is intended that when words such as “a,” “an,” “at least one,” “at least a portion” are used there is no intention to limit the claim to only one item unless specifically stated to the contrary in the claim. Further, when the language “at least a portion” and/or “a portion” is used the item may include a portion and/or the entire item unless specifically stated to the contrary. While the invention has been illustrated and described in detail in the drawings and foregoing description, the same is to be considered as illustrative and not restrictive in character, it being understood that only the selected embodiments have been shown and described and that all changes, modifications and equivalents that come within the spirit of the invention as defined herein or by any of the following claims are desired to be protected.

What is claimed is:

1. A method, comprising:
sending a number of transmit vectors from a first wireless communication device to a second wireless communication device, the transmit vectors being representative of spatial transmission filters;
in response to the transmit vectors, determining a number of receive vectors with the second wireless communication device, the receive vectors being representative of spatial reception filters; and
determining a representation of angular spectrum for wireless communication between the first device and the second device as a function of the transmit vectors and the receive vectors; and
controlling a multiple antenna output transmission of at least one of the first device and the second device in accordance with the representation of angular spectrum.

2. The method of claim 1, in which the controlling of the multiple antenna output transmission includes performing transmission beamforming as a function of the angular spectrum.

3. The method of claim 1, in which the controlling of the multiple antenna output transmission includes selecting a subset of a number of antennas as a function of angle spread.

4. The method of claim 3, wherein the first device includes a memory stored with information representing a number of different subsets of the antennas.

5. The method of claim 1, which includes:
at the second device, determining receiving and transmit angle spread;
determining signal space dimension;
selecting a subset of several second device antennas as a function of the receive angle spread;
sending the signal space dimension and transmit angle spread to the first device from the second device; and
selecting a subset of several first device antennas as a function of the transmit angle spread.

6. The method of claim 1, in which the determining of the angular spectrum includes:
representing a communication space with a number of discrete cells;
determining a discrete transmit array manifold relative to the discrete cells from a corresponding long-term transmission correlation matrix; and
calculating the transmit vectors as a function of the discrete transmit array manifold and the discrete receive manifold.

7. The method of claim 1, in which the controlling of the multiple output transmission includes determining an optimal basis for a transmit signal space.

8. The method of claim 1, wherein the first device is a handheld or body-worn personal communication device, and which includes:
responding to operator input to the first device; and
from the first device, providing an output detectable with one or more senses of the operator.

9. Apparatus, comprising:
an antenna array including a first number of antenna elements;
a second number of analog RF circuits, the second number being less than the first number, the analog RF circuits each being operable to perform RF analog front end transformation of a respective one of a corresponding number of communication signal streams,
processing circuitry including a memory to store information representative of a plurality of different subsets of the antenna elements, the processing circuitry being operable to determine one or more values representative of an angle spread for multiple wireless communication paths, select one of the different subsets based on the one or more values, and generate one or more output signals corresponding to the one of the different subsets of the antenna elements; and
a routing circuit coupled between the antenna elements and the analog RF circuits, the routing circuit being responsive to the one or more output signals to connect each element in the one of the different subsets of the antenna elements to a different one of the analog RF circuits.

10. The apparatus of claim 9, wherein the RF analog circuits are each coupled to a corresponding analog-to-digital converter, the multiple wireless communication paths correspond to receiver pathways, and the angle spread corresponds to a reception angular spread.

11. The apparatus of claim 9, wherein the apparatus includes means for wirelessly transmitting information and means for wirelessly receiving information.

12. The apparatus of claim 9, wherein the apparatus is in the form of a handheld or body-worn personal communication device and includes one or more operator input devices and one or more operator output devices.

13. The apparatus of claim 9, wherein the processing circuitry includes means for estimating an angular spectrum and means for providing the angle spread as a function of the angular spectrum.

14. The apparatus of claim 9, wherein the RF analog circuits are each coupled to a corresponding digital-to-analog converter, the multiple wireless communication paths correspond to transmission pathways, and the angle spread corresponds to a transmission angular spread.

15. The apparatus of claim 9, wherein the routing circuit includes means for selectively switching the analog RF circuits between the different subsets of the antenna elements in response to the processing circuitry.

16. A method, comprising:
operating a device including several antenna elements;
specifying a number of different subsets of the antenna elements in the device;
with the device, determining one or more values representative of angle spread for multiple wireless communication paths;
selecting one of the different subsets of the antenna elements based on the one or more values representative of the angle spread; and
wirelessly communicating with the one of the different subsets of the antennas.

17. The method of claim 16, wherein the wirelessly communicating with the one of the different subsets of the antenna elements includes transmitting information from the device, the angle spread corresponds to a transmission angular spread, and the multiple wireless communication paths correspond to transmission pathways.

18. The method of claim 16, which includes:
repeating the determining from time-to-time to provide a plurality of different values corresponding to a number of different angle spreads; and
switching between the different subsets of the antenna elements in response to the different angle spreads.

19. The method of claim 16, wherein the device includes several analog RF front end circuits numbering fewer than the antennas and which include switching between the different subsets of the antenna elements in correspondence to different angle spreads with the device.

20. The method of claim 16, which includes estimating an angular spectrum of associated with the multiple wireless communication paths and wherein the determining of the one or more values is performed as a function of the angular spectrum.

21. The method of claim 16, which includes storing information in a memory of the device and representing the different subsets of the antenna elements with the information.

22. The method of claim 16, wherein the device is a handheld or body-worn personal communication device, and which includes:
responding to operator input to the device; and
providing an output detectable with one or more senses of the operator.

23. The method of claim 16, wherein the wirelessly communicating with the one of the different subsets of the antenna elements includes receiving information from the device, the angle spread corresponds to a receiver angular spread, and the multiple wireless communication paths correspond to reception pathways.

24. A method, comprising:
with a first multiple antenna wireless communication device, determining an angular domain representation of a transmit channel spectrum for a second multiple antenna wireless communication device;
transmitting the angular domain representation from the first multiple antenna wireless communication device to the second multiple antenna wireless communication device; and
controlling a transmission from the second multiple antenna wireless communication device to the first multiple antenna wireless communication device as a function of the angular domain representation.

25. The method of claim 24, wherein the controlling of the multiple antenna output transmission includes performing transmission beamforming as a function of the angular spectrum.

26. The method of claim 24, which includes:
at the first device, determining receiving and transmit angle spread;
determining signal space dimension;
selecting a subset of several first device antennas as a function of the receive angle spread;
sending the signal space dimension and transmit angle spread to the second device from the first device; and
selecting a subset of several second device antennas as a function of the transmit angle spread.

27. The method of claim 26, wherein the first device includes a memory stored with information representing a number of different subsets of the first device antennas.

28. The method of claim 24, which includes determining an angular spectrum.

29. A system, comprising:
a first wireless communication device including a number of first device antenna elements, first device processing circuitry, and a first device transmitter to provide a wireless transmission of transmitter vectors corresponding to spatial filters;
a second communication device including a number of second device antenna elements, a second device receiver to receive one or more signals corresponding to the wireless transmission of the transmitter vectors, and second device processing circuitry to generate receiver vectors corresponding to the signals; and
one or more of the first device processing circuitry and the second device processing circuitry being structured to determine angular spectrum as a function of the transmitter vectors, the receiver vectors, a transmit array manifold, and a receive array manifold.

30. The system of claim 29, wherein the first device includes a memory stored with information corresponding to a number of different subsets of the first device antenna elements.

31. The system of claim 30, wherein the first device includes means for selecting one of the different subsets as a function of transmit angle spread.

32. The system of claim 31, wherein the second device includes means for determining the transmit angle spread and a receive angle spread as a function of the angular spectrum and means for sending one or more signals corresponding to the transmit angle spread to the first device.

33. The system of claim 29, wherein the first device includes means for determining an optimal basis for a transmit signal space as a function of the angular spectrum.

34. The system of claim 29, wherein the first device includes means for performing transmission beamforming as a function of a transmit channel spectrum received from the second device, and the second device includes means for determining the transmit channel spectrum as a function of the angular spectrum.

35. The system of claim 29, wherein the first device and the second device are each a handheld or body-worn two-way personal communication device.
